(19) United States
(12) Patent Application Publication
(10) Pub. No.: US 2009/0262782 A1
(43) Pub. Date: Oct. 22, 2009

(54) SOLAR-POWERED TEMPERATURE MEASURING APPARATUS

(75) Inventors: Kun-Te KO, Sanchong City (TW); Ching-Ling Yang, Sanchong City (TW)

Correspondence Address: RABIN & Berdo, PC, 1101 14TH STREET, NW, SUITE 500, WASHINGTON, DC, 20005, US

(73) Assignee: AViTA Corporation, Taipei County (TW)

(21) Appl. No.: 12/355,043

(22) Filed: Jan. 16, 2009

(30) Foreign Application Priority Data
Apr. 22, 2008 (TW) 097206900

(51) Int. Cl. G01K 1/00; H02J 7/00

(52) U.S. Cl. 374/152; 320/101; 374/E01.001

(57) ABSTRACT

A solar-powered temperature measuring apparatus includes: a case, at least one part of a surface thereof including a solar panel used for converting visible light to electric energy; a first connection portion, positioned in the case; and a temperature measurer, accepted in the case, including: a main body; a second connection portion, positioned on the main body and used for connecting with the first connection portion; and a charging element, connected electrically to the second connection portion and used for storing electric energy generated form the solar panel. By this means, visible light is converted to electric energy to conform to each country's current environmental protection policies, and the charging element may be charged at any time to solve the problem of a conventional clinical thermometer being unable to be used due to insufficient cell power.

### CROSS-REFERENCES TO RELATED APPLICATIONS

This non-provisional application claims priority under 35 U.S.C. §119(a) on Patent Application No(s). 97206900 filed in Taiwan, R.O.C. on Apr. 22, 2008 the entire contents of which are hereby incorporated by reference.

### FIELD OF THE INVENTION

The present invention relates to a temperature measuring apparatus, and more particularly to a solar-powered temperature measuring apparatus.

### BACKGROUND

Generally, a mercury clinical thermometer or digital clinical thermometer is most commonly used to measure body temperature. The mercury clinical thermometer uses the principle of thermal expansion and contraction to measure body temperature with mercury sealed in a glass tube. However, such a thermometer is highly unsafe, since the poisonous mercury could be released easily due to the fragility of the glass. The digital clinical thermometer is used to measure body temperature by means of infrared rays or heat conduction, and an electrical cell is used to power it. However, the average user cannot use it regularly because the digital clinical thermometer is usually considered a spare medical apparatus, such that the battery power is often too low to operate the thermometer, and a used battery must be replaced with a new one or recharged, which is rather inconvenient.

Furthermore, due to the fast progress of technology, electrical cells are used in more and more electronic products as a power supply, the excessive consumption of energy results in an increase of carbon monoxide emissions, contributing significantly to the global greenhouse effect when these electronic products are used on a large scale. However, reducing energy waste and making efforts in the development of new energy sources have become the most important new topic nowadays, concerning more people and placing a greater importance on environmental protection.

### SUMMARY OF THE INVENTION

For improving a structure of a digital clinical thermometer to prevent it being limited by the power cell, solving the problem of being unable to use the conventional clinical thermometer due to the insufficiency of the cell's power, and conforming to environmental protection concepts, the present invention is proposed.

To attain to these objects, the present invention proposes a solar-powered temperature measuring apparatus, including:
a case, at least one part of a surface thereof including a solar panel used for converting visible light to electric energy;
a first connection portion, positioned in the case; and
a temperature measurer, positioned in the case, including:
   a main body;
   a second connection portion, positioned on the main body and used for connecting with the first connection portion; and
   a charging element, connected electrically to the second connection portion and used for storing electric energy generated form the solar panel.

According to the present invention, when a solar-powered temperature measuring apparatus is not used, a solar panel may then convert visible light to electric energy and store the electric energy in a charging element so as to obtain power. When a user uses the solar-powered temperature measuring apparatus of the present invention to measure temperature, sufficient cell power always allows the user to use the temperature measuring apparatus and the user does not have to worry that the temperature measuring apparatus is unable to be used due to insufficient cell power; this can improve user convenience a great deal. Besides, the present invention converts visible light to electric energy, which is then used as a power source; it may further conform to each country's current environmental protection policies.

### BRIEF DESCRIPTION OF THE DRAWINGS

The present invention can be more fully understood by reference to the following description and accompanying drawings, in which:

FIGS. 1 and 2 are perspective views, showing a solar-powered temperature measuring apparatus of a first preferred embodiment according to the present invention;

FIG. 3 is a block diagram, showing a solar-powered temperature measuring apparatus of the first preferred embodiment according to the present invention;

FIG. 4 is a perspective view, showing a solar-powered temperature measuring apparatus of a second preferred embodiment according to the present invention;

FIG. 5 is a block diagram, showing a solar-powered temperature measuring apparatus of the second preferred embodiment according to the present invention;

FIG. 6 is a perspective view, showing a solar-powered temperature measuring apparatus of a third preferred embodiment according to the present invention; and

FIG. 7 is a block diagram, showing a solar-powered temperature measuring apparatus of the third preferred embodiment according to the present invention.

### DETAILED DESCRIPTION OF THE PREFERRED EMBODIMENTS

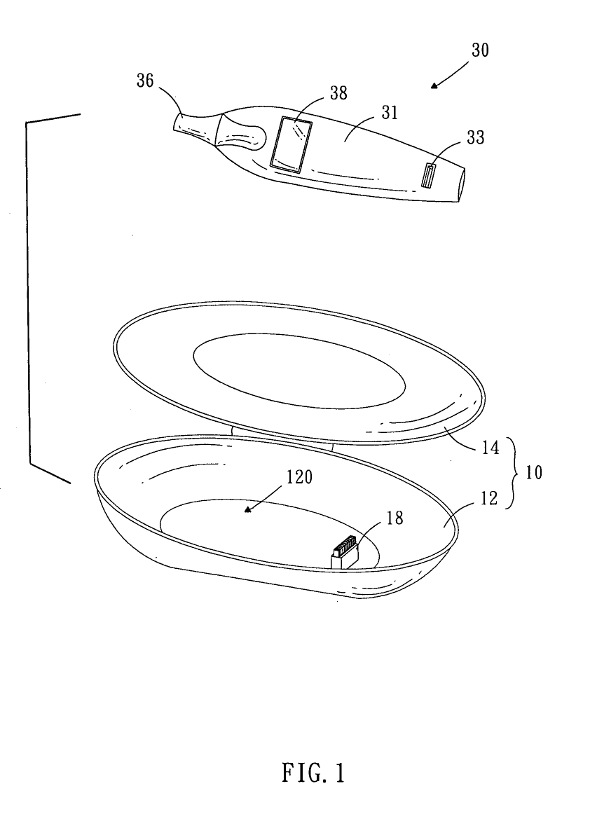

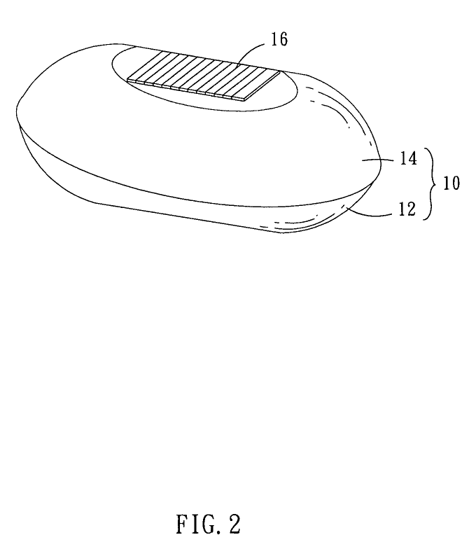

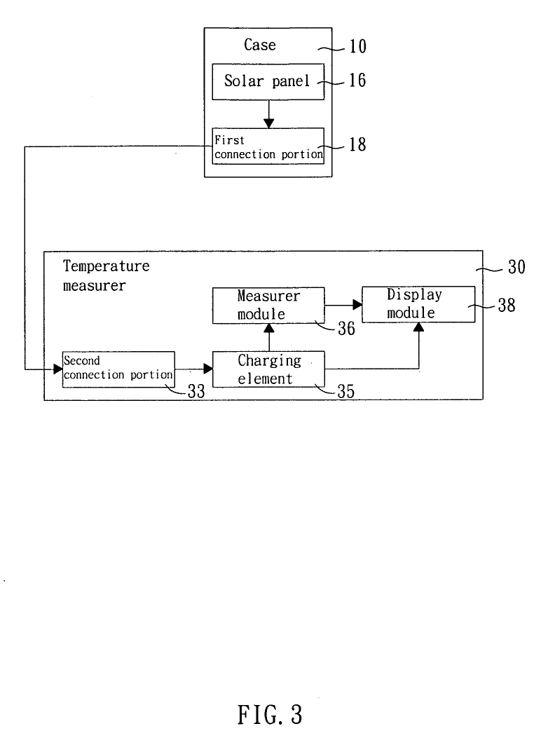

Please refer to FIGS. 1, 2 and 3. FIGS. 1 and 2 are perspective views, showing a solar-powered temperature measuring apparatus of a first preferred embodiment according to the present invention. FIG. 3 is a block diagram, showing a solar-powered temperature measuring apparatus of the first preferred embodiment according to the present invention.

A solar-powered temperature measuring apparatus according to the present invention includes a case 10 and a temperature measurer 30.

The case 10 is constituted by a seat 12 and a cover 14 corresponding to each other, in which the seat 12 assumes an approximate rectangular shape and a center thereof is formed with an accepting space 120. One side of the cover 14 is pivotally coupled to the seat 12 and used for covering the seat 12 to shield the accepting space 120, and at least one part of a surface thereof is disposed with a solar panel 16 used for converting visible light to electric energy. In the present embodiment, the solar panel 16 is preferably installed on the surface of the cover 14, but not limited to this according to the present invention; it also may be installed on a surface of the seat 12 or the surfaces of both the seat 12 and the cover 14. In addition, the solar panel 16 may be a flexible thin-film solar cell such that at least one of the seat 12 and the cover 14 may be made by the solar panel 16, where the flexible thin-film solar cell is chosen from one among an organic polymer solar cell, amorphous Si solar cell, dye-sensitized solar cell, μ-crystal Si solar cell and compound solar cell.

The case 10 mentioned above is constituted of the seat 12 and the cover 14, where one side of the cover 14 is pivotally coupled to the seat 12, but it is only an example, it is not limited to this according to the present invention, a person skilled in the art may adjust its structure depend on practical need.

Furthermore, a first connection portion 15 may be installed at a proper position in the case 10, where the first connection portion 18 may be preferably in an accepting space 120 of the seat 12, is but not limited to this.

The temperature measurer 30 is accepted in the accepting space 120 of the seat 12 and provided with a rectangular main body 31, and a second connection portion 33 used for connecting with the first connection portion 1 8 in the case 10 is installed on the main body 31. Furthermore, a charging element 35 is installed in the main body 31; it is connected electrically to the second connection portion 33 and used for storing electric energy generated from the solar panel 16, where the charging element 35 is chosen from one group constituted by a lithium cell, lithium ion battery, polymeric lithium cell, lead-acid storage battery, nickel-metal-hydride battery and Nickel-Cadmium battery.

One side of the main body 31 may further be installed with a measurer module 36 on the temperature measurer 30 adapted to use the electric energy stored in the charging element 35 in the main body 31 to measure temperature, where the measurer module 36 may preferably be used to measure a human body's forehead temperature or ear temperature, but is not limited to this according to the present invention. In addition, the temperature measurer 30 may further be installed with a display module 38 on the main body 31; it is used for displaying a measured result of the measurer module 36 by using the electric energy stored in the charging element 35.

When a user uses the temperature measuring apparatus in daily life, he only needs to place the temperature measurer 30 in the accepting space 120 of the seat 12 to allow the second connection portion 33 to be connected to the first connection portion 18 in the seat 12 and use the cover 14 to cover seat 12 to shield the accepting space 120, and the temperature measurer 30 can then be accepted in the case 10, Meanwhile, the solar panel 16 on the surface of the case 10 cam be used to convert visible light to electric energy, and the electric energy is transmitted to the charging element 35 via the first connection portion 18 and the second connection portion 33 in sequence to enable the charging element 35 to carry out energy storage so as to ensure the charging element 35 has sufficient power at any time.

The user only needs to lift the cover 14 while the temperature measuring apparatus is in use and exert force to separate the connection portion 33 of the temperature measurer 30 from the first connection portion 18, and may then take out the temperature measure 30 from the accepting space 120 of the seat 12. A human body temperature such as forehead temperature or ear temperature may be measured through the measurer module 36 after the temperature measurer 30 is taken out and a measured result is displayed on a display module 38 so as to enable the user to judge whether he is under an attack of fever or his body temperature is too high or not.

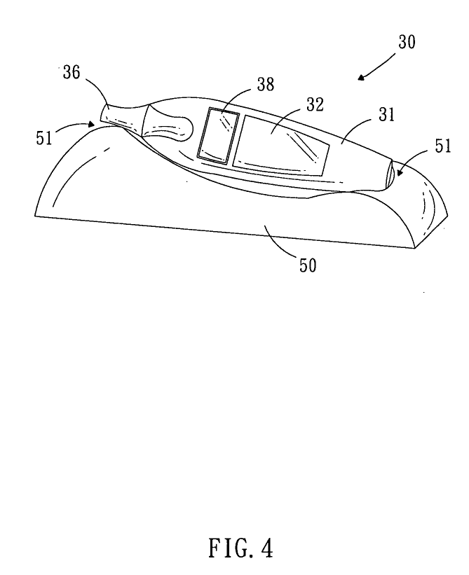

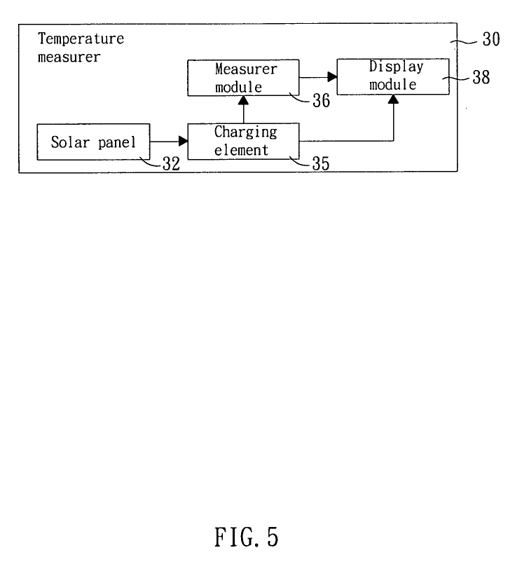

Please refer to FIGS. 4 and 5. FIG. 4 is a perspective view, showing a solar-powered temperature measuring apparatus of a second preferred embodiment according to the present invention. FIG. 5 is a block diagram, showing a solar-powered temperature measuring apparatus of the second preferred embodiment according to the present invention.

A solar-powered temperature measuring apparatus according to the present invention includes a temperature measurer 30 and a support portion 50.

The temperature measurer 30 has a rectangular main body 31 and at least one part of a surface of the main body 30 is disposed with a solar panel 32 used for converting visible light to electric energy. Besides, the solar panel 32 may be a flexible thin-film solar cell. Hence, the main body 31 may be made by the solar panel 32, in which the flexible thin-film solar cell is chosen from one among an organic polymer solar cell, amorphous Si solar cell, dye-sensitized solar cell, μ-crystal Si solar cell and compound solar cell.

A charging element 35 used for storing the electric energy generated from the solar panel 32 is installed in the main body 31, where the charging element 35 is chosen from one group constituted by a lithium cell, lithium ion battery, polymeric lithium cell, lead-acid storage battery, nickel-metal-hydride battery and Nickel-Cadmium battery. Furthermore, one side of the main body 31 is installed with a measurer module 36 adapted to use the electric energy stored in the charging element 35 in the main body 31 to measure temperature, where the measurer module 36 may preferably be used to measure a human body's forehead temperature or ear temperature, but is not limited to this according to the present invention. In addition, the temperature measurer 30 may further be installed with a display module 38 on the main body 31; it is used for displaying a measured result of the measurer module 36 by using the electric energy stored in the charging element 35.

The support frame 50 assumes an approximate rectangular shape, and two ends thereof are respectively formed with a raised support portion 51 used for supporting the main body 51 of the temperature measurer 30, where the structure of the support frame 50 is only an example here; it is not limited to this according to the present invention, the person skilled in the art may adjust its structure depending on a practical need.

When a user does not use the temperature measuring apparatus of the present invention in daily life, he only needs to place the temperature measurer 30 on the support frame 50 and uses the support portions on the two ends of the support frame 50 to support the temperature measurer 30, and temperature measurer 30 can then be stored stably. Meanwhile, the solar panel 32 of the surface of the main body 31 may be used to convert visible light to electric energy and transmit it to the charging element 35 to carry out the energy storage so as to ensure the charging element 35 has sufficient power at any time. The user may take out temperature measurer 30 from the support frame 50 directly while the temperature measuring apparatus is being used. A human body temperature such as forehead temperature or ear temperature may be measured through the measurer module 36 after the temperature measurer 30 is taken out and a measured result is displayed on a display module 38 so as to enable the user to judge whether he is under an attack of fever or his body temperature is too high or not.

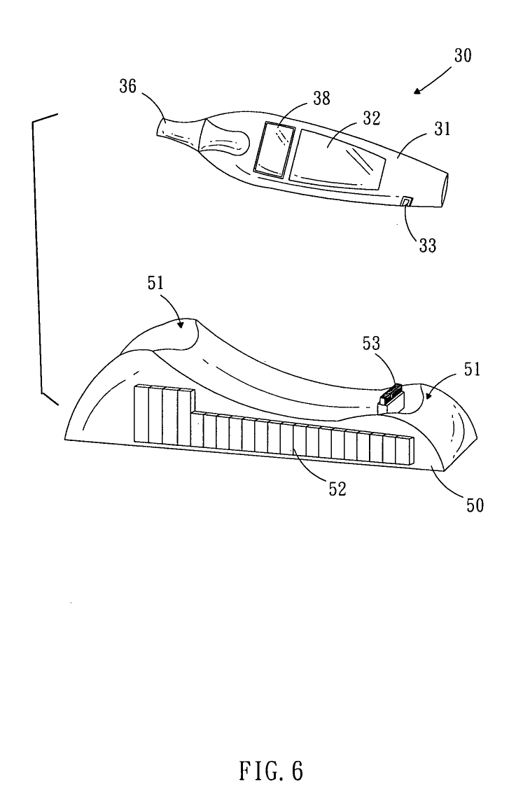

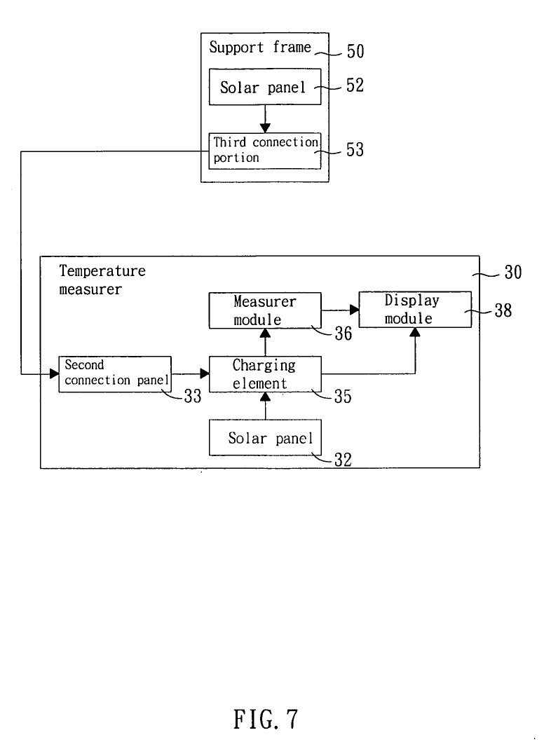

Please refer to FIGS. 6 and 7. FIG. 6 is a perspective view, showing a solar-powered temperature measuring apparatus of a third preferred embodiment according to the present invention. FIG. 7 is a block diagram, showing a solar-powered temperature measuring apparatus of the third preferred embodiment according to the present invention.

In the present embodiment, at least one part of a surface of the support frame 50 is disposed with a solar panel 52 used for converting visible light to electric energy. Furthermore, the support frame 50 may also made from the solar panel 52.

In addition, a third connection portion 53 is disposed on the support frame 50, and a second connection portion 33 is disposed on the main body 31 of the temperature measurer 30, When the temperature measurer 30 is placed on the support frame 50, the second connection portion 33 of the main body 31 is connected to the third connection portion 53 of the support frame 50 such that the solar panel 32 on the surface of the main body 31 and the solar panel 52 on the support frame 50 can be used to convert visible light to electric energy simultaneously, and the electric energy converted by the solar panel 52 on the support frame 50 is transmitted to the charging element 35 to store energy via the third connection portion 53 and the second connection portion 33 in sequence. In this way, not only does the charging element 35 ensure that sufficient power is available at any time, but the charging efficiency of the charging element 35 is also increased greatly.

The present invention uses a solar panel to convert visible light to electric energy thereby being used as a power source; it can avoid unnecessary energy consumption and conform to each country's current environmental protection policies. In addition, charging can be carried out with the charging element at any time, to ensure there is sufficient power for a user to measure temperature when the temperature measuring apparatus of the present invention is used, so that the user does not have to worry whether the temperature measuring apparatus is unable to be used due to insufficient power, substantially increasing convenience.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A solar-powered temperature measuring apparatus, comprising:
a case, at least one part of a surface thereof comprising a solar panel used for converting visible light to electric energy;
a first connection portion, positioned in the case; and
a temperature measurer, accepted in the case, comprising:
a main body;
a second connection portion, positioned on the main body and used for connecting to the first connection portion; and
a charging element, electrically connected to the second connection portion and used for storing the electric energy generated from the solar panel.

2. The solar-powered temperature measuring apparatus according to claim 1, wherein the case further comprises:
a seat, used for accepting the temperature measurer; and
a cover, used for covering the seat.

3. The solar-powered temperature measuring apparatus according to claim 2, wherein the cover is pivotally coupled to the seat.

4. The solar-powered temperature measuring apparatus according to claim 2, wherein the solar panel is positioned on one among the seat, the cover and the combination thereof.

5. The solar-powered temperature measuring apparatus according to claim 2, wherein the first connection portion is positioned in the seat.

6. The solar-powered temperature measuring apparatus according to claim 1, wherein the case is made by the solar panel.

7. The solar-powered temperature measuring apparatus according to claim 6, wherein the solar panel is a flexible thin-film solar cell.

8. The solar-powered temperature measuring apparatus according to claim 7, wherein the flexible thin-film solar cell is one among an organic polymer solar cell, amorphous Si solar cell, dye-sensitized solar cell, μ-crystal Si solar cell and compound solar cell.

9. The solar-powered temperature measuring apparatus according to claim 1, wherein the temperature measurer further comprises a measurer module, positioned on one side of the main body and using the electric energy stored in the charging element to measure temperature.

10. The solar-powered temperature measuring apparatus according to claim 9, wherein the temperature measurer further comprises a display module, positioned on the main body and using the electric energy stored in the charging element to display a measured result of the measurer module.

11. The solar-powered temperature measuring apparatus according to claim 1, wherein the charging element is chosen from one group constituted by a lithium cell, lithium ion battery, polymeric lithium cell, lead-acid storage battery, nickel-metal-hydride battery and Nickel-Cadmium battery.

12. A solar-powered temperature measuring apparatus, comprising:
a main body, at least one part of a surface thereof comprising a solar panel used for converting solar energy to electric energy;
a charging element, positioned in the main body and used for storing the electric energy generated from the solar panel;
a measurer module, positioned on one side of the main body and using the electric energy stored in the charging element to measure temperature.

13. The solar-powered temperature measuring apparatus according to claim 12, further comprising a support frame used for supporting the main body.

14. The solar-powered temperature measuring apparatus according to claim 13, wherein at least one part of a surface of the support frame comprises the solar panel.

15. The solar-powered temperature measuring apparatus according to claim 14, wherein the support frame further comprises a third connection portion, the main body comprises a second connection portion used for connecting the third connection portion to allow the charging element to store the electric energy generated from the solar panel of the support frame.

16. The solar-powered temperature measuring apparatus according to claim 12, wherein the main body is made by the solar panel.

17. The solar-powered temperature measuring apparatus according to claim 16, wherein the solar panel is a flexible thin-film solar cell.

18. The solar-powered temperature measuring apparatus according to claim 17, wherein the flexible thin-film solar cell is one among an organic polymer solar cell, amorphous Si solar cell, dye-sensitized solar cell, μ-crystal Si solar cell and compound solar cell.

19. The solar-powered temperature measuring apparatus according to claim 12, wherein the temperature measurer further comprises a display module, positioned on the main body and using the electric energy stored in the charging element to display a measured result of the measurer module.

20. The solar-powered temperature measuring apparatus according to claim 12, wherein the charging element is chosen from one group constituted by lithium cell, lithium ion battery, polymeric lithium cell, lead-acid storage battery, nickel-metal-hydride battery and Nickel-Cadmium battery.
